(19) United States
(12) Patent Application Publication
(10) Pub. No.: US 2024/0236668 A9
(43) Pub. Date: Jul. 11, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Menghan WANG, Shenzhen (CN); Shuang LIANG, Shenzhen (CN); Jinguo ZHU, Shenzhen (CN)

(73) Assignee: ZTE CORPORATION, Shenzhen (CN)

(21) Appl. No.: 18/501,098

(22) Filed: Nov. 3, 2023

Related U.S. Application Data
(63) Continuation of application No. PCT/CN2021/109305, filed on Jul. 29, 2021.

(51) Int. Cl. H04W 12/06; H04L 9/40; H04W 48/18

(52) U.S. Cl. CPC H04W 12/06; H04L 63/0892; H04W 48/18

(57) ABSTRACT

Method, device, and computer program product for wireless communication are provided. A method includes receiving, by an access and mobility management node, information of a network slice maximum bit rate for a wireless communication terminal authorized by an Authentication, Authorization, and Accounting-Server, AAA-S, from a network slice specific authentication and authorization node.

This application is a Continuation of PCT Application No. PCT/CN2021/109305, filed Jul. 29, 2021, incorporated herein by reference in its entirety.

### TECHNICAL FIELD

This document is directed generally to wireless communications, in particular to 5^{th} generation (5G) wireless communications.

### BACKGROUND

A network slice refers to a logical network that has specific network capabilities and network characteristics. A network slice instance refers to a set of Network Function instances and the required resources (e.g., compute, storage, and networking resources), and the set of Network Function instances and the required resources form a deployed network slice. A UE-Slice-MBR indicates a network slice maximum bit rate for an S-NSSAI (Single-network slice Selection Assistant Information) for a UE (user equipment), which applies to 3GPP (3^{rd} Generation Partnership Project) access type. The UE-Slice-MBR includes a UL (uplink) value and a DL (downlink) value.

The UE-Slice-MBR is used to determine the maximum aggregated bit rate of the network slice for a UE. Typically, the UE-Slice-MBR is managed by the UDM (Unified Data Management). Confusion might arise when the UE-Slice-MBR is to be updated by a third party, e.g., by an AAA-S (Authorization, Authorization, and Accounting-Server).

### SUMMARY

The present disclosure relates to methods, devices, and computer program products for providing the UE-Slice-MBR.

One aspect of the present disclosure relates to a wireless communication method. In an embodiment, the wireless communication method includes receiving, by an access and mobility management node, information of a network slice maximum bit rate for a wireless communication terminal authorized by an Authentication, Authorization, and Accounting-Server, AAA-S, from a network slice specific authentication and authorization node.

Another aspect of the present disclosure relates to a wireless communication method. In an embodiment, the wireless communication method includes: receiving, by a network slice specific authentication and authorization node, information of a network slice maximum bit rate for a wireless communication terminal authorized by an Authentication, Authorization, and Accounting-Server, AAA-S, from the AAA-S or an Authentication, Authorization, and Accounting-Proxy, AAA-P; and transmitting, by the network slice specific authentication and authorization node, the information of the network slice maximum bit rate for the wireless communication terminal authorized by the AAA-S to an access and mobility management node.

Another aspect of the present disclosure relates to a wireless communication method. In an embodiment, the wireless communication method includes: receiving, by a policy control node, information of a network slice maximum bit rate for a wireless communication terminal authorized by an Authentication, Authorization, and Accounting-Server, AAA-S, from an access and mobility management node; and transmitting, by the policy control node, the information of the network slice maximum bit rate for the wireless communication terminal authorized by the policy control node to the access and mobility management node according to the information of the network slice maximum bit rate for the wireless communication terminal authorized by the AAA-S.

Another aspect of the present disclosure relates to a wireless communication method. In an embodiment, the wireless communication method includes: receiving, by an Authentication, Authorization, and Accounting-Proxy, AAA-P, information of a network slice maximum bit rate for a wireless communication terminal authorized by an Authentication, Authorization, and Accounting-Server, AAA-S, from the AAA-S; and transmitting, by the AAA-P, the information of the network slice maximum bit rate for the wireless communication terminal authorized by the AAA-S to a network slice specific authentication and authorization node.

Another aspect of the present disclosure relates to a wireless communication method. In an embodiment, the wireless communication method includes transmitting, by an Authentication, Authorization, and Accounting-Server, AAA-S, information of a network slice maximum bit rate for a wireless communication terminal authorized by the AAA-S to an Authentication, Authorization, and Accounting-Proxy, AAA-P, or a network slice specific authentication and authorization node.

Another aspect of the present disclosure relates to a wireless communication node. In an embodiment, the wireless communication node includes a communication unit and a processor. The processor is configured to: receive information of a network slice maximum bit rate for a wireless communication terminal authorized by an Authentication, Authorization, and Accounting-Server, AAA-S, from a network slice specific authentication and authorization node.

Another aspect of the present disclosure relates to a wireless communication node. In an embodiment, the wireless communication node includes a communication unit and a processor. The processor is configured to: receive information of a network slice maximum bit rate for a wireless communication terminal authorized by an Authentication, Authorization, and Accounting-Server, AAA-S, from the AAA-S or an Authentication, Authorization, and Accounting-Proxy, AAA-P; and transmit the information of the network slice maximum bit rate for the wireless communication terminal authorized by the AAA-S to an access and mobility management node.

Another aspect of the present disclosure relates to a wireless communication node. In an embodiment, the wireless communication node includes a communication unit and a processor. The processor is configured to: receive information of a network slice maximum bit rate for a wireless communication terminal authorized by an Authentication, Authorization, and Accounting-Server, AAA-S, from an access and mobility management node; and transmit the information of the network slice maximum bit rate for the wireless communication terminal authorized by the policy control node to the access and mobility management node according to the information of the network slice maximum bit rate for the wireless communication terminal authorized by the AAA-S.

Another aspect of the present disclosure relates to a wireless communication node. In an embodiment, the wireless communication node includes a communication unit and a processor. The processor is configured to: receive information of a network slice maximum bit rate for a wireless communication terminal authorized by an Authentication, Authorization, and Accounting-Server, AAA-S, from the AAA-S; transmit the information of the network slice maximum bit rate for the wireless communication terminal authorized by the AAA-S to a network slice specific authentication and authorization node.

Another aspect of the present disclosure relates to a wireless communication node. In an embodiment, the wireless communication node includes a communication unit and a processor. The processor is configured to: transmit information of a network slice maximum bit rate for a wireless communication terminal authorized by the AAA-S to an Authentication, Authorization, and Accounting-Proxy, AAA-P, or a network slice specific authentication and authorization node.

Various embodiments may preferably implement the following features:

Preferably or in some embodiments, the access and mobility management node is configured to transmit the information of the network slice maximum bit rate for the wireless communication terminal authorized by the AAA-S to a policy control node to acquire the information of the network slice maximum bit rate for the wireless communication terminal authorized by the policy control node.

Preferably or in some embodiments, the access and mobility management node is configured to transmit the information of the network slice maximum bit rate for the wireless communication terminal authorized by the AAA-S or the information of the network slice maximum bit rate for the wireless communication terminal authorized by a policy control node to the radio access network, and the information of the network slice maximum bit rate for the wireless communication terminal authorized by the policy control node is acquired by transmitting the information of the network slice maximum bit rate for the wireless communication terminal authorized by the AAA-S to the policy control node.

Preferably or in some embodiments, the access and mobility management node is configured to receive the information of the network slice maximum bit rate for the wireless communication terminal authorized by the AAA-S during a network slice specific authentication and authorization, NSSAA, procedure for a piece of Single-Network Slice Selection Assistant Information, S-NSSAI, for the network slice.

Preferably or in some embodiments, the access and mobility management node is configured to subscribe updates of the information of the network slice maximum bit rate for the wireless communication terminal authorized by the AAA-S from the network slice specific authentication and authorization node.

Preferably or in some embodiments, the access and mobility management node is configured to receive the information of the network slice maximum bit rate for the wireless communication terminal authorized by the AAA-S after a successful NSSAA procedure for a piece of S-NSSAI for the network slice.

Preferably or in some embodiments, the network slice specific authentication and authorization node is configured to receive the information of the network slice maximum bit rate for the wireless communication terminal authorized by the AAA-S during a network slice specific authentication and authorization, NSSAA, procedure for a piece of Single-Network Slice Selection Assistant Information, S-NSSAI, for a network slice.

Preferably or in some embodiments, the network slice specific authentication and authorization node is configured to subscribe updates of the information of the network slice maximum bit rate for the wireless communication terminal authorized by the AAA-S from the AAA-S or the AAA-P.

Preferably or in some embodiments, the network slice specific authentication and authorization node is configured to receive the information of the network slice maximum bit rate for the wireless communication terminal authorized by the AAA-S after a successful NSSAA procedure for a piece of S-NSSAI for a network slice.

Preferably or in some embodiments, the policy control node is configured to receive the information of the network slice maximum bit rate for the wireless communication terminal authorized by the AAA-S during a network slice specific authentication and authorization, NSSAA, procedure for a piece of Single-Network Slice Selection Assistant Information, S-NSSAI, for a network slice.

Preferably or in some embodiments, the policy control node is configured to receive the information of the network slice maximum bit rate for the wireless communication terminal authorized by the AAA-S after a successful NSSAA procedure for a piece of S-NSSAI for a network slice.

Preferably or in some embodiments, the AAA-P is configured to receive the information of the network slice maximum bit rate for the wireless communication terminal authorized by the AAA-S during a network slice specific authentication and authorization, NSSAA, procedure for a piece of Single-Network Slice Selection Assistant Information, S-NSSAI, for a network slice.

Preferably or in some embodiments, the AAA-P is configured to subscribe updates of the information of the network slice maximum bit rate for the wireless communication terminal authorized by the AAA-S from the AAA-S.

Preferably or in some embodiments, the AAA-P is configured to receive the information of the network slice maximum bit rate for the wireless communication terminal authorized by the AAA-S after a successful NSSAA procedure for a piece of S-NSSAI for a network slice.

Preferably or in some embodiments, the AAA-S is configured to transmit the information of the network slice maximum bit rate for the wireless communication terminal authorized by the AAA-S during a network slice specific authentication and authorization, NSSAA, procedure for a piece of Single-Network Slice Selection Assistant Information, S-NSSAI, for a network slice.

Preferably or in some embodiments, the AAA-S is configured to receive a subscription for updates of the information of the network slice maximum bit rate for the wireless communication terminal authorized by the AAA-S from the AAA-P or the network slice specific authentication and authorization node.

Preferably or in some embodiments, the AAA-S is configured to transmit the information of the network slice maximum bit rate for the wireless communication terminal authorized by the AAA-S after a successful NSSAA procedure for a piece of S-NSSAI for a network slice.

The present disclosure relates to a computer program product including a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices, and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows 5G System (5GS) architecture according to an embodiment of the present disclosure.

FIG. 2 shows a procedure for a UE registering for a set of network slices according to an embodiment of the present disclosure.

FIGS. 3A to 3D show a schematic diagram for providing a UE-Slice-MBR according to an embodiment of the present disclosure.

FIG. 4 shows a schematic diagram for providing a UE-Slice-MBR according to an embodiment of the present disclosure.

FIG. 5 shows a schematic diagram for providing a UE-Slice-MBR according to an embodiment of the present disclosure.

FIGS. 6A and 6B show a schematic diagram for providing a UE-Slice-MBR according to an embodiment of the present disclosure.

FIG. 7 shows a schematic diagram for providing a UE-Slice-MBR according to an embodiment of the present disclosure.

FIG. 8 shows an example of a schematic diagram of a wireless communication node according to an embodiment of the present disclosure.

FIG. 9 shows a flowchart of a wireless communication method according to an embodiment of the present disclosure.

FIG. 10 shows a flowchart of another wireless communication method according to an embodiment of the present disclosure.

FIG. 11 shows a flowchart of another wireless communication method according to an embodiment of the present disclosure.

FIG. 12 shows a flowchart of another wireless communication method according to an embodiment of the present disclosure.

FIG. 13 shows a flowchart of another wireless communication method according to an embodiment of the present disclosure.

### DETAILED DESCRIPTION

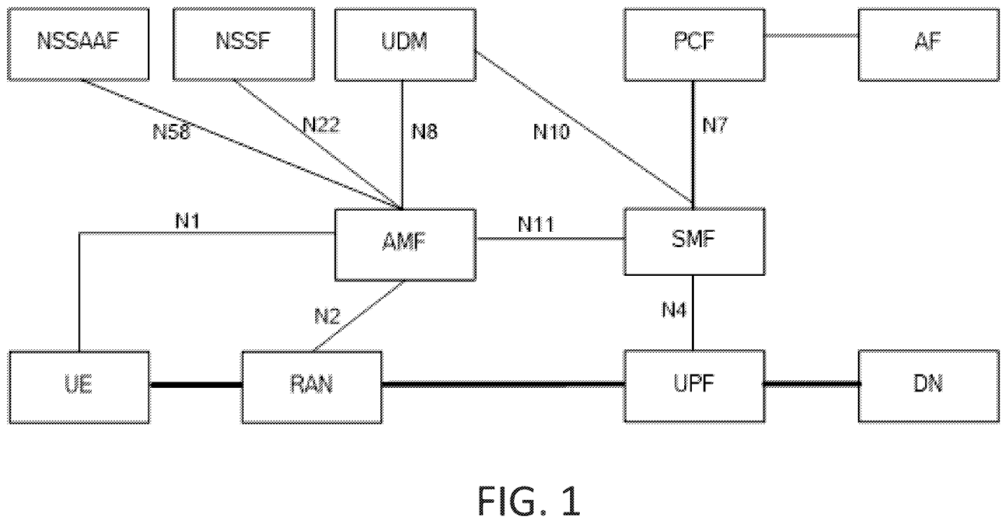

FIG. 1 shows 5G System (5GS) architecture. In an embodiment, 5GS architecture consists of the following network functions (NFs):

1) UE, User Equipment.

2) RAN, Radio Access Network.

3) AMF, Access and Mobility Management Function. This network function (NF) includes functionalities such as UE Mobility Management, Reachability Management, Connection Management and Registration Management. The AMF terminates the RAN control plane (CP) interface N2 and NAS (non-access stratum) interface N1, NAS ciphering and integrity protection. It also distributes the SM (Structural-to-Modular) NAS to the proper SMFs (Session Management Functions) via N11 interface.

During the registration procedure, the AMF may determine the Allowed NSSAI (network slice Selection Assistance information) and the Rejected NSSAI including rejection cause based on the Requested NSSAI received from the UE. The AMF further determines the Registration Area within which the UE can use all S-NSSAIs (Single-network slice Selection Assistance information) of the Allowed NSSAI. The AMF sends the Allowed NSSAI, the Rejected NSSAI including rejection cause and the Registration Area to the UE.

The AMF may trigger the NSSAA procedure for the S-NSSAIs requiring a Network Slice-Specific Authentication and Authorization (NSSAA), or based on the change of subscription information, or based on the triggering of the AAA-S (Authorization, Authorization, and Accounting-Server).

4) UDM, Unified Data Management. This NF manages the subscription profile for the UEs. The subscription data is stored in the Unified Data Repository (UDR). The subscription information includes the data used for Mobility Management and Session Management. The AMF retrieves the subscription data from the UDM.

5) NSSF, network slice Selection Function. This NF supports the following functionality: selecting the set of network slice instances serving the UE; determining the Allowed NSSAI and, if needed, the mapping to the HPLMN S-NSSAIs; determining the Configured NSSAI and, if needed, the mapping to the HPLMN S-NSSAIs; determining the AMF Set to be used to serve the UE, or, based on a configuration, a list of candidate AMF(s), possibly by querying the Network Repository Function (NRF).

6) SMF, Session Management Function. This NF includes the following functionalities: session establishment, modification, and release; UE IP address allocation and management; selection and control of user plane (UP) function, etc.

7) UPF, User Plane Function. This NF serves as an anchor point for intra-/inter-radio access technology (RAT) mobility and as the external PDU session point of interconnect to the Data Network (DN). The UPF also routes and forwards the data packet according to the indication from the SMF. It also buffers the downlink (DL) data when the UE is in an idle mode.

8) AF, Application Function. The AF interacts with the 3GPP Core Network in order to provide services, for example, to support application influence on traffic routing, accessing NEF, interacting with the policy framework for policy control, etc.

9) PCF, Policy Control Function. The PCF supports unified policy framework to govern network behavior. The PCF provides the access management policy to the AMF, or the session management policy to the SMF, or the UE policy to the UE. The PCF can access the UDR to obtain the subscription information relevant to policy decisions.

10) NSSAAF, Network Slice Specific Authentication and Authorization Function. The NSSAAF supports NSSAA with an Authorization, Authorization, and Accounting-Server (AAA-S). If the AAA-S belongs to a third party, the NSSAAF may contact the AAA-S via an Authorization, Authorization, and Accounting-Proxy (AAA-P).

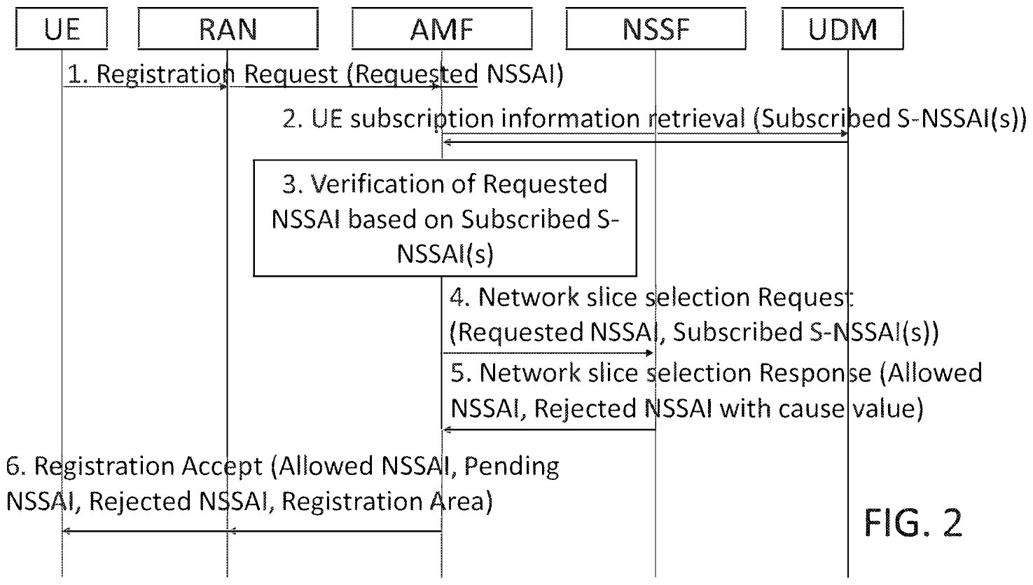

FIG. 2 shows a procedure for a UE registering for a set of network slices.

1. When a UE registers over an Access Type with a PLMN, the UE may provide a Requested NSSAI containing the S-NSSAI(s) corresponding to the network slice(s) which the UE requests to register for to the network in NAS layer. The Requested NSSAI may be at least one of:
the Default Configured NSSAI, e.g., if the UE has neither Configured NSSAI nor Allowed NSSAI for the serving PLMN, in which the Configured NSSAI may be configured by the serving PLMN, and the Configured NSSAI may represent the S-NSSAI that the current serving network can provide services for users;
the Configured-NSSAI, or a subset thereof, e.g., if the UE has no Allowed NSSAI for the Access Type for the serving PLMN;
the Allowed-NSSAI for the Access Type over which the Requested NSSAI is sent or a subset thereof; or
the Allowed-NSSAI for the Access Type over which the Requested NSSAI is sent or a subset thereof, and one or more S-NSSAIs from the Configured-NSSAI are not in the Allowed NSSAI for the Access Type.

2. When the AMF selected by the RAN during Registration Procedure receives the UE Registration request, the AMF may query the UDM to retrieve UE subscription information including the Subscribed S-NSSAIs.

3. The AMF verifies whether the S-NSSAI(s) in the Requested NSSAI are permitted based on the Subscribed S-NSSAIs. To identify each of the Subscribed S-NSSAIs in the Requested NSSAI, the AMF may use the mapped HPLMN S-NSSAIs provided by the UE in the NAS message.

4. When the UE context in the AMF does not include an Allowed NSSAI for the corresponding Access Type, the AMF queries the NSSF for network slice selection, unless the AMF is allowed to determine whether it can serve the UE based on configuration of the AMF. The IP address or FQDN (Fully Qualified Domain Name) of the NSSF is locally configured in the AMF.

5. The NSSF returns the AMF the Allowed NSSAI. The NSSF may also return the Rejected S-NSSAI(s) including rejection cause indicating the reason why the S-NSSAI(s) is rejected, e.g., rejected NSSAI for the current PLMN, rejected NSSAI for the current Registration Area, etc.

6. The AMF sends a Registration Accept message to the UE including the Allowed NSSAI, the mapped HPLMN NSSAI of the Allowed NSSAI (if it is provided), and the Rejected S-NSSAI(s) including rejection cause and the Registration Area.

The Allowed NSSAI contains only the S-NSSAIs that, based on the subscription information, do not require a Network Slice-Specific Authentication and Authorization (NSSAA) and the S-NSSAIs, based on the UE Context in the AMF, having a successful NSSAA in previous procedure, regardless of the Access Type.

If the UE indicates that it supports NSSAA in the UE 5GMM (5G Mobility Management) Core Network Capability in the Registration Request, the AMF includes in the Pending NSSAI the S-NSSAIs that map to an S-NSSAI of the HPLMN, in which the S-NSSAI of the HPLMN has an indication that it is subject to the NSSAA in the subscription information. In such a case, the AMF may trigger an NSSAA procedure, unless, based on Network policies, the NSSAA procedure for the same S-NSSAI has already been initiated on another Access Type. The UE may not attempt re-registration with the S-NSSAIs included in the list of Pending NSSAIs until the NSSAA procedure has been completed, regardless of the Access Type. Once the NSSAA procedure is completed for all S-NSSAIs, the AMF may trigger a UE Configuration Update procedure to deliver an Allowed NSSAI containing the S-NSSAIs for which the NSSAA is successful, and rejected NSSAIs with an appropriate rejection cause value.

The Mapping of Pending NSSAI described above indicates the mapping of each S-NSSAI of the Pending NSSAI for the Serving PLMN to the HPLMN S-NSSAIs.

If the UE does not indicate its support for NSSAA in the UE 5GMM Core Network Capability in the Registration Request, and the Requested NSSAI includes S-NSSAIs which map to the HPLMN S-NSSAIs subject to the NSSAA, the AMF includes those S-NSSAIs in the Requested NSSAI in the Rejected S-NSSAIs.

If no S-NSSAI can be provided in the Allowed NSSAI because: (1) all the S-NSSAI(s) in the Requested NSSAI are to be subject to the NSSAA; or (2) no Requested NSSAI was provided or none of the S-NSSAIs in the Requested NSSAI matches any of the Subscribed S-NSSAIs, and all the S-NSSAI(s) marked as default in the Subscribed S-NSSAIs are to be subject to the NSSAA, the AMF may provide an empty Allowed NSSAI.

Upon receiving an empty Allowed NSSAI and a Pending NSSAI, the UE is registered in the PLMN but may wait for the completion of the NSSAA procedure without attempting to use any service provided by the PLMN on any access, except e.g., emergency services, until the UE receives an Allowed NSSAI.

The serving AMF may determine a Registration Area such that all S-NSSAIs in the Allowed NSSAI are available in all Tracking Areas of the Registration Area.

After completion of the Registration procedure, the UE may request to establish a PDU (Protocol Data Unit) Session. The Requested S-NSSAI of the PDU Session is derived from the URSP (UE route selection policy) rules or UE Local Configuration. The Requested S-NSSAI is within the Allowed NSSAI.

The UE-Slice-MBR is used to control the maximum aggregated bit rate of the network slice for a UE. In some approaches, the UE-Slice-MBR may be managed by the UDM. In the prior art, it might be unclear how to update the UE-Slice-MBR by an AAA-S (e.g., provided by a third party).

Embodiments of the present disclosure provide a mechanism to support the update of the UE-Slice-MBR by an AAA-S, which can be provided by a third party. In the following paragraphs, some examples are described.

### Example 1: Update UE-Slice-MBR by AAA-S During NSSAA Procedure

In this example, the UE-Slice-MBR is updated by an AAA-S during a Network Slice-Specific Authentication and Authorization (NSSAA) procedure.

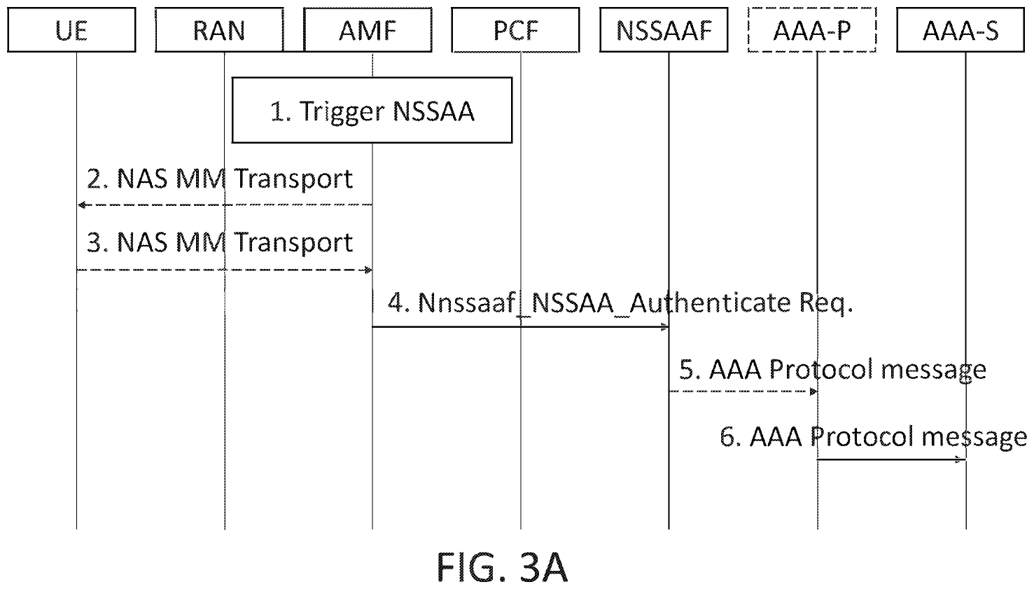

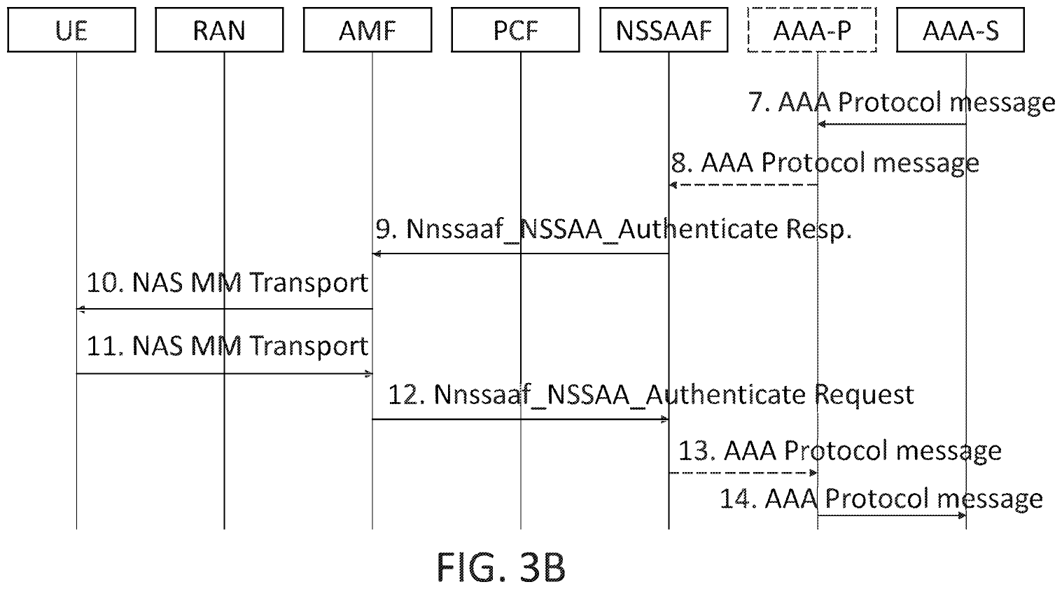

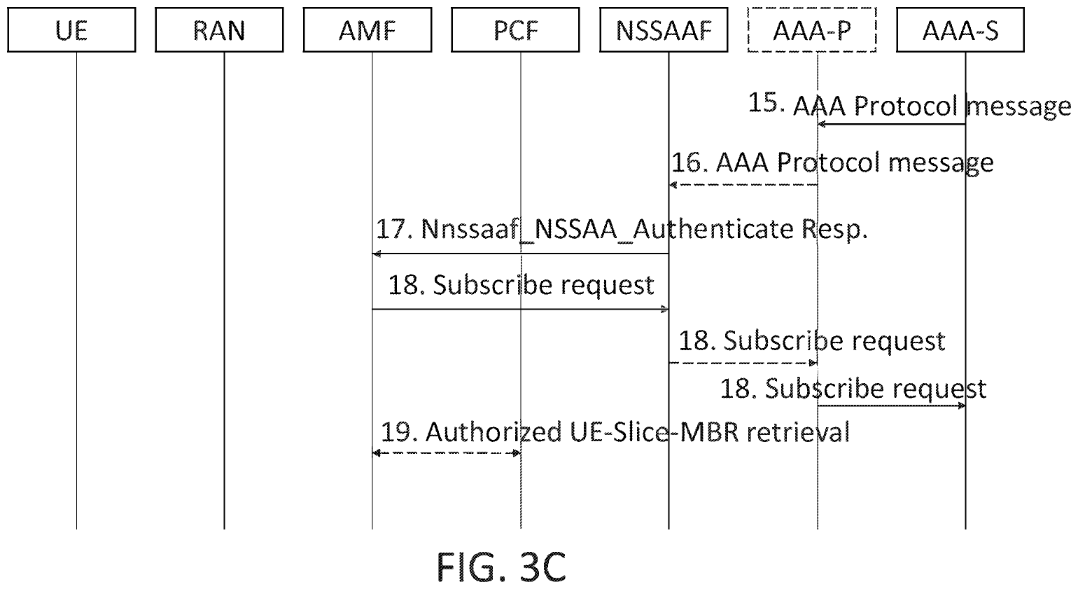

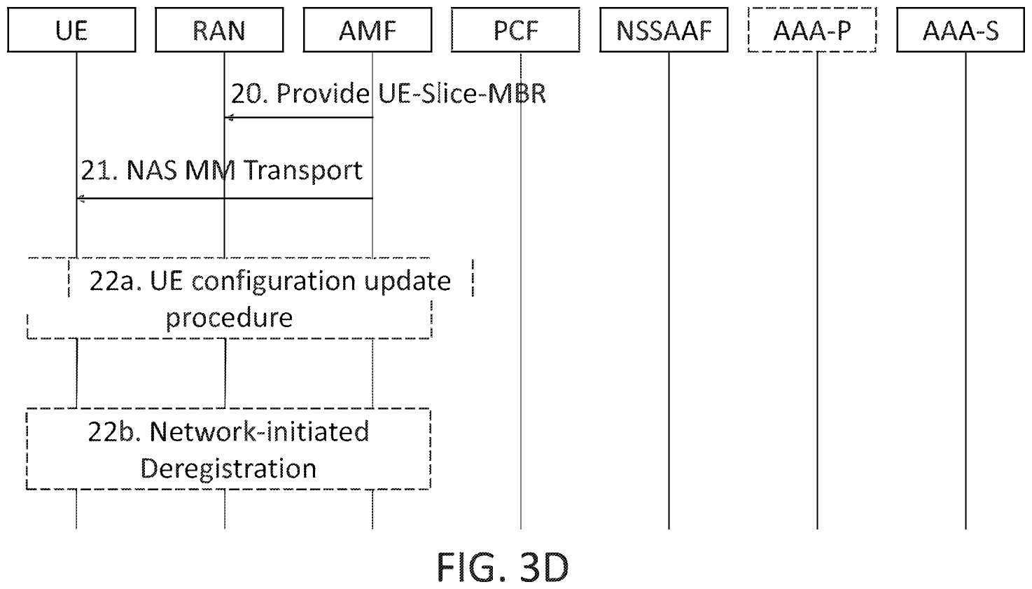

FIGS. 3A to 3D show the NSSAA procedure with the UE-Slice-MBR updated by an AAA-S.

1. The AMF may trigger an NSSAA procedure for S-NSSAIs requiring an NSSAA (e.g., as a result of the registration procedure), or based on the change of subscription information, or based on the triggering of the AAA-S.

If the NSSAA procedure is triggered as a result of the registration procedure, the AMF may determine, based on the UE Context in the AMF, that for some or all S-NSSAI(s) subject to the NSSAA, the UE has already been authenticated following the registration procedure on a first access. In such a situation, depending on the NSSAA result (e.g., success or failure) from the previous registration procedure, the AMF may decide, based on the Network policies, to skip the NSSAA for these S-NSSAIs during the registration on a second access.

If the NSSAA procedure corresponds to a re-authentication and re-authorization procedure triggered as a result of the AAA Server-triggered UE re-authentication and re-authorization for one or more S-NSSAIs, or triggered by the AMF based on the operator policies or a subscription change and if the S-NSSAIs requiring an NSSAA are included in the Allowed NSSAI for each Access Type, the AMF selects an Access Type to be used to perform the NSSAA procedure based on network policies.

2. The AMF may send an EAP (Extensible Authentication Protocol) ID (Identity) Request for the S-NSSAI in an NAS (non-access stratum) MM (Mobility Management) Transport message including the S-NSSAI. In an embodiment, the included S-NSSAI is the S-NSSAI of the H-PLMN, not a locally mapped S-NSSAI.

3. The UE provides the EAP ID Response for the S-NSSAI alongside the S-NSSAI in an NAS MM Transport message towards the AMF.

4. The AMF sends the EAP ID Response to the NSSAAF, for example, in an Nnssaaf_NSSAA_Authenticate Request. In an embodiment, the Nnssaaf_NSSAA_Authenticate Request is a request message for NSSAAF used in the NSSAA procedure. In an embodiment, the Nnssaaf_NSSAA_Authenticate Request includes the EAP ID Response, the GPSI (Generic Public Subscription Identifier), and the S-NSSAI. In an embodiment, if the UE subscription includes multiple GPSIs, the AMF may use any GPSI in the list provided by the UDM for the NSSAA procedures.

5. If an AAA-P is deployed (e.g., because the AAA-S belongs to a third party and the operator deploys a proxy towards third parties), the NSSAAF forwards the EAP ID Response to the AAA-P. Otherwise, the NSSAAF forwards the message directly to the AAA-S. The NSSAAF is configured to send the NSSAA requests to the appropriate AAA-S based on local configuration of AAA-S address per S-NSSAI. The NSSAAF transmits the EAP ID Response to the AAA-P or the AAA-S by using an AAA Protocol message, which is supported by the AAA-P and the AAA-S.

6. The AAA-P forwards the EAP ID Response to the AAA-S together with the S-NSSAI and the GPSI. The AAA-S stores the GPSI to create an association with the EAP Identity in the EAP ID Response, so the AAA-S can later use it to revoke authorization, or to trigger re-authentication, or to modify the AAA-S Authorized UE-Slice-MBR.

7. If the AAA-P is deployed, the AAA-S transmits an AAA Protocol message to the AAA-P, which includes an EAP message, the GPSI, and the S-NSSAI. Otherwise, the AAA-S transmits the AAA Protocol message to the NSSAAF directly.

8. The AAA-P forwards the AAA Protocol message to the NSSAAF, which includes the EAP message, the GPSI, and the S-NSSAI.

9. The NSSAAF transmits an Nnssaaf_NSSAA_Authenticate Response to the AMF, which includes the EAP message, the GPSI, and the S-NSSAI.

10. The AMF transmits an NAS MM Transport message to the UE, which includes the EAP message and the S-NSSAI.

11. The UE transmits an NAS MM Transport message to the AMF, which includes the EAP message and the S-NSSAI.

12. The AMF transmits an Nnssaaf_NSSAA_Authenticate Request to the NSSAAF, which includes the EAP message, the GPSI, and the S-NSSAI.

13. If the AAA-P is deployed, the NSSAAF transmits an AAA Protocol message to the AAA-P, which includes an EAP message, an address of the AAA-S, the GPSI, and the S-NSSAI. Otherwise, the AAA-S transmits the AAA Protocol message to the AAA-S directly.

14. The AAA-P transmits an AAA Protocol message to the AAA-S, which includes the EAP message, the GPSI, and the S-NSSAI.

15. The EAP authentication completes (e.g., the AAA-S determines the EAP authentication succeeds or fails. The AAA-S stores the S-NSSAI for which the authorization is granted, so that the AAA-S may decide to trigger a re-authentication and re-authorization procedure or to modify the AAA-S Authorized UE-Slice-MBR based on its local policies. An EAP Success message, the GPSI, the S-NSSAI for the UE, and the AAA-S Authorized UE-Slice-MBR associated with the S-NSSAI for the UE are delivered to the AAA-P (or if the AAA-P is not present, directly to the NSSAAF).

In an embodiment, the AAA-S may transmit a message (e.g., an AAA Protocol message) to the AAA-P or the NSSAAF including the EAP Success message, the GPSI, the S-NSSAI, and the AAA-S Authorized UE-Slice-MBR associated with the S-NSSAI for the UE.

16. If the AAA-P is used, the AAA-P sends a message (e.g., an AAA Protocol message) to the NSSAAF, and the AAA Protocol message includes the EAP Success message, the Authorized UE-Slice-MBR associated with the S-NSSAI for the UE, the S-NSSAI, and the GPSI.

17. The NSSAAF sends a response (e.g., an Nnssaaf_NSSAA_Authenticate Response) to the AMF, in which the response includes the EAP Success message, the Authorized UE-Slice-MBR associated with the S-NSSAI for the UE, the S-NSSAI, and the GPSI.

18. The AMF may subscribe the notifications of the updates of the AAA-S Authorized UE-Slice-MBR from the NSSAAF. In such a case, the NSSAAF may subscribe the notifications of the updates of AAA-S Authorized UE-Slice-MBR from the AAA-P (or if the AAA-P is not present, directly from the AAA-S).

19. The AMF stores the AAA-S Authorized UE-Slice-MBR for the S-NSSAI for the UE in the UE Context in the AMF. In an embodiment, the AAA-S Authorized UE-Slice-MBR associated with the S-NSSAI for the UE has a higher priority than a subscribed UE-Slice-MBR associated with the same S-NSSAI received from the UDM.

In an embodiment, if the AAA-S Authorized UE-Slice-MBR is received and dynamic PCC (Policy and Charging Control) is deployed, the AMF sends the AAA-S Authorized UE-Slice-MBR instead of the subscribed UE-Slice-MBR from the UDM to the PCF to acquire a PCF Authorized UE-Slice-MBR.

In an embodiment, the PCF provides the PCF Authorized UE-Slice-MBR to the AMF according to the AAA-S Authorized UE-Slice-MBR.

In an embodiment, in the Network Slice-Specific Re-Authentication and Re-Authorization procedure triggered by the AAA-S, if the AMF receives the AAA-S Authorized UE-Slice-MBR, the AMF may report the received AAA-S Authorized UE-Slice-MBR to the PCF by triggering the Policy Control Request Trigger.

20. The AMF provides the PCF Authorized UE-Slice-MBR or the AAA-S Authorized UE-Slice-MBR to the RAN during the NSSAA procedure or after the NSSAA procedure in the INITIAL CONTEXT SETUP REQUEST message or in the UE CONTEXT MODIFICATION REQUEST message. The UE-Slice-MBR is applied by the RAN (e.g., used in the RAN).

21. The AMF transmits a message (e.g., an NAS MM Transport message) including the EAP Success message to the UE. The AMF may store the EAP result for each S-NSSAI the NSSAA procedure is executed for.

22a. If a new Allowed NSSAI (i.e. including new S-NSSAIs in a Requested NSSAI for which the NSSAA procedure succeeded and/or excluding any S-NSSAI(s) in the existing Allowed NSSAI for the UE for which the procedure has failed) and/or new Rejected S-NSSAIs (i.e. including S-NSSAI(s) in the existing Allowed NSSAI for the UE for which the procedure has failed, or new requested S-NSSAI(s) for which the NSSAA procedure failed) need to be delivered to the UE, or if the AMF re-allocation is required, the AMF initiates the UE Configuration Update procedure, for each Access Type. If the Network Slice-Specific Re-Authentication and Re-Authorization fails and there are PDU session(s) established that are associated with the S-NSSAI for which the NSSAA procedure failed, the AMF may initiate the PDU Session Release procedure to release the PDU sessions with the appropriate cause value.

22b. If the NSSAA fails for all S-NSSAIs (if any) in the existing Allowed NSSAI for the UE and (if any) for all S-NSSAIs in the Requested NSSAI, the AMF may execute the Network-initiated Deregistration procedure and it may include in the explicit De-Registration Request the list of Rejected S-NSSAIs, each of them with the appropriate rejection cause value.

### Example 2: Update UE-Slice-MBR by AAA-S After Successful NSSAA Procedure

In this example, the UE-Slice-MBR is updated by the AAA-S after the NSSAA procedure is successfully executed for the S-NSSAI for the UE.

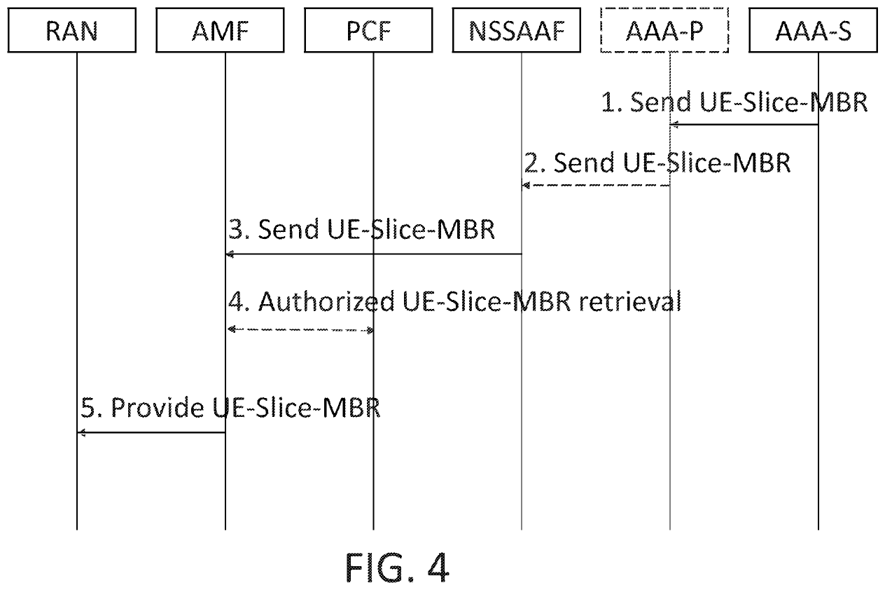

FIG. 4 shows the procedure for updating the UE-Slice-MBR after a successful NSSAA procedure.

1. The NSSAA procedure is successfully executed for the S-NSSAI for the UE. The AAA-S stores the corresponding GPSI and S-NSSAI. If the AAA-S Authorized UE-Slice-MBR associated with the GPSI and S-NSSAI was allocated, the AAA-S stores the allocated AAA-S Authorized UE-Slice-MBR with the corresponding GPSI and S-NSSAI. The AAA-S intends to modify the AAA-S Authorized UE-Slice-MBR based on its local policies. The modified AAA-S Authorized UE-Slice-MBR associated with the S-NSSAI for the UE is delivered to the AAA-P (or if the AAA-P is not present, directly to the NSSAAF) with the GPSI and the S-NSSAI.

2. If the AAA-P is used, the AAA-P sends a message including the UE-Slice-MBR, the S-NSSAI, and the GPSI to the NSSAAF.

3. The NSSAAF sends a message including the UE-Slice-MBR, the S-NSSAI, and the GPSI to the AMF.

4. If the modified AAA-S Authorized UE-Slice-MBR is received and dynamic PCC is deployed, the AMF may send the modified AAA-S Authorized UE-Slice-MBR to the PCF to acquire a PCF Authorized UE-Slice-MBR.

5. The AMF provides the PCF Authorized UE-Slice-MBR or the modified AAA-S Authorized UE-Slice-MBR to the RAN during this update procedure or after this update procedure in the INITIAL CONTEXT SETUP REQUEST message or in the UE CONTEXT MODIFICATION REQUEST message. The UE-Slice-MBR is applied by the RAN (e.g., used in the RAN).

### Example 3: Provide Subscribed UE-Slice-MBR To UDM By Third Party AF Before Registration Procedure

In this example, the subscribed UE-Slice-MBR in the UDM is provided by an AF (e.g., provided by a third party) before the registration procedure.

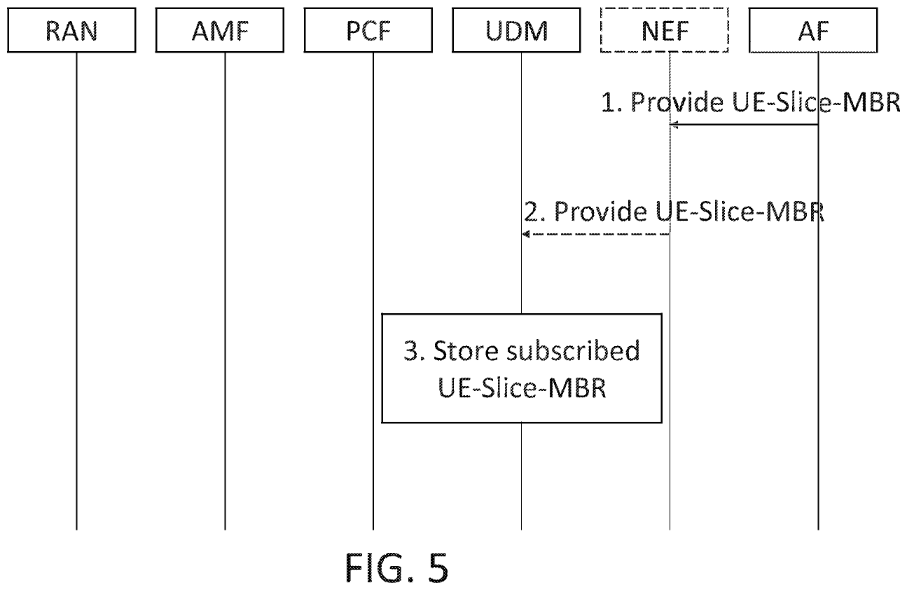

FIG. 5 shows the procedure for providing the UE-Slice-MBR in the UDM before the registration procedure.

1. The third party AF intends to provide the UE-Slice-MBR associated with the S-NSSAI for the UE based on its local policies. The UE-Slice-MBR associated with the S-NSSAI for the UE is delivered to an NEF (Network Exposure Function) if the third party AF is not trusted by the network. Alternatively, the UE-Slice-MBR is delivered to the UDM directly if the third party AF is trusted by the network.

2. The NEF forwards the UE-Slice-MBR received from the third party AF to the UDM.

3. The UDM stores the UE-Slice-MBR received from the NEF or AF as the subscribed UE-Slice-MBR.

### Example 4: Update Subscribed UE-Slice-MBR In UDM By Third Party AF During Registration Procedure

In this example, the subscribed UE-Slice-MBR in the UDM is updated by an AF (e.g., provided by a third party) during the registration procedure.

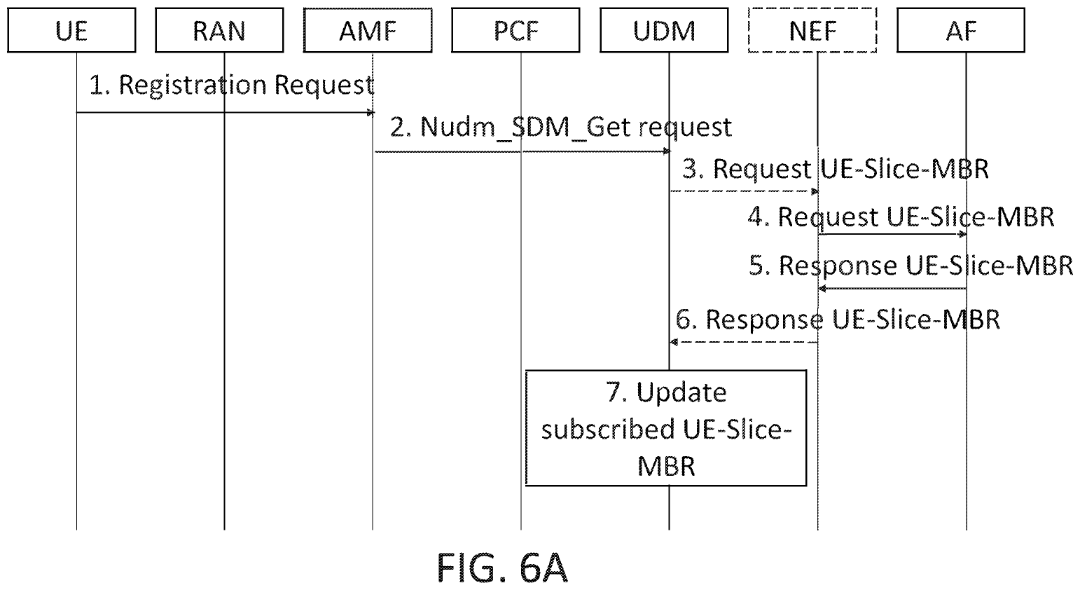

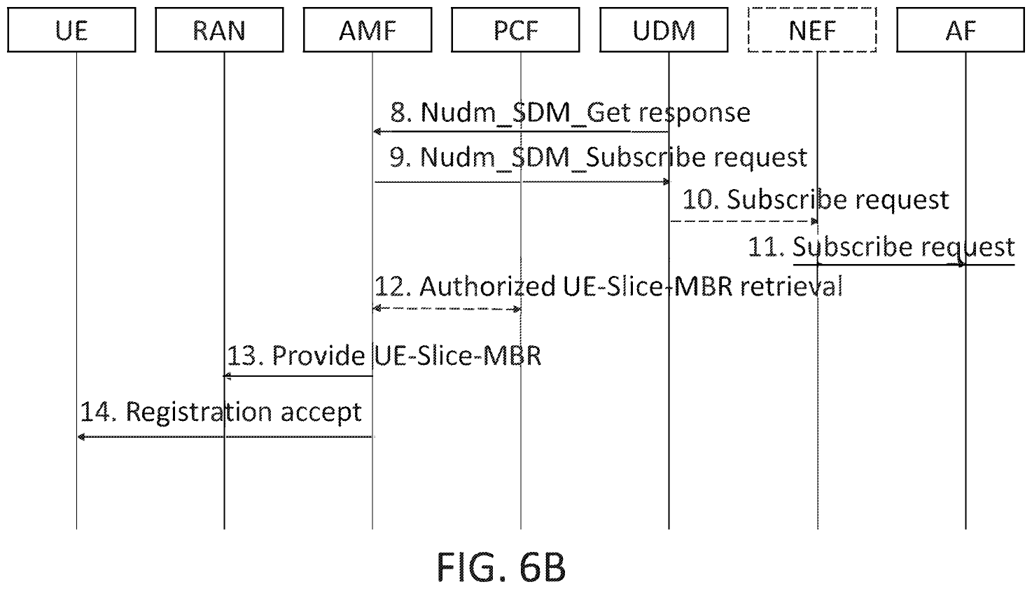

FIGS. 6A and 6B show the procedure for updating the UE-Slice-MBR in the UDM during the registration procedure.

1. The UE initiates initial registration, emergency registration or mobility registration update procedure with the AMF by sending REGISTRATION REQUEST message with the 5GS registration type IE (information element) indicating “initial registration”, “emergency registration” or “mobility registration updating”.

2. Upon receiving the REGISTRATION REQUEST message, the AMF performs the registration procedure. As part of the registration procedure, the AMF invokes an Nudm_SDM_Get service operation to the UDM to retrieve the subscription information for the UE.

3. If the third party AF is not trusted by the network, the UDM sends the request for the UE-Slice-MBR to the NEF. If the third party AF is trusted by the network, the UDM sends request of UE-Slice-MBR to the AF directly.

4. The NEF forwards the request for the UE-Slice-MBR provided by the UDM to the third party AF.

5. If the third party AF is not trusted by the network, the AF sends the UE-Slice-MBR to the NEF. If the third party AF is trusted by the network, the AF sends the UE-Slice-MBR to the UDM directly.

6. The NEF forwards the UE-Slice-MBR received from the third party AF to the UDM.

7. The UDM updates the subscribed UE-Slice-MBR associated with the S-NSSAI for the UE with the received UE-Slice-MBR from the NEF or the AF.

8. The UDM provides the updated UE-Slice-MBR to the AMF.

9. As part of the registration procedure, the AMF also invokes an Nudm_SDM_Subscribe service operation to the UDM to subscribe notifications of updates of the subscription information for the UE.

10. If the third party AF is not trusted by the network, the UDM subscribes the notifications of the updates of UE-Slice-MBR from the NEF. Alternatively, if the third party AF is trusted by the network, the UDM subscribes the notifications of the updates of UE-Slice-MBR from the AF directly.

11. The NEF forwards the subscription request from the UDM to the third party AF.

12. Optionally, the AMF sends the subscribed UE-Slice-MBR received from the UDM to the PCF. In this case, the PCF may provide the authorized UE-Slice-MBR to the AMF.

13. The AMF provides the authorized UE-Slice-MBR from the PCF or the subscribed UE-Slice-MBR from the UDM to the RAN during the registration procedure or after the registration procedure in the INITIAL CONTEXT SETUP REQUEST message or in the UE CONTEXT MODIFICATION REQUEST message. The UE-Slice-MBR is enforced in the RAN.

14. The AMF sends the REGISTRATION ACCEPT message to the UE.

### Example 5: Update Subscribed UE-Slice-MBR In UDM By Third Party AF

In this example, the subscribed UE-Slice-MBR in the UDM is updated by an AF (e.g., provided by a third party) at, for example, any time after the registration procedure.

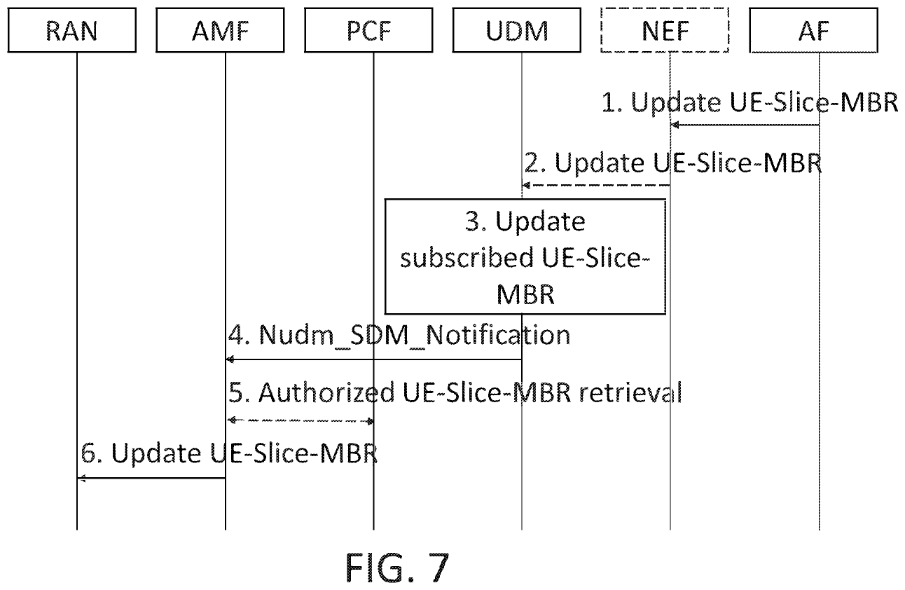

FIG. 7 shows the procedure for updating the UE-Slice-MBR in the UDM.

1. The third party AF intends to modify the UE-Slice-MBR associated with the S-NSSAI for the UE based on its local policies. The modified UE-Slice-MBR associated with the S-NSSAI for the UE is delivered to an NEF (Network Exposure Function) if the third party AF is not trusted by the network. Alternatively, the modify UE-Slice-MBR is delivered to the UDM directly if the third party AF is trusted by the network.

2. The NEF forwards the modified UE-Slice-MBR received from the third party AF to the UDM.

3. The UDM updates the subscribed UE-Slice-MBR for the S-NSSAI for the UE with the received UE-Slice-MBR from the NEF or the AF.

4. The UDM provides the updated UE-Slice-MBR to the AMF.

5. Optionally, the AMF sends the updated UE-Slice-MBR received from the UDM to the PCF. In this case, the PCF may provide the authorized UE-Slice-MBR to the AMF.

6. The AMF provides the authorized UE-Slice-MBR from the PCF or the updated UE-Slice-MBR from the UDM to the RAN during this updating procedure or after this updating procedure in the INITIAL CONTEXT SETUP REQUEST message or in the UE CONTEXT MODIFICATION REQUEST message. The updated UE-Slice-MBR is enforced in the RAN.

According to an embodiment of the present disclosure, the AMF receives the AAA-S Authorized UE-Slice-MBR from the NSSAAF. In an embodiment, the AMF receives the AAA-S Authorized UE-Slice-MBR from the NSSAAF during the NSSAA procedure. In another embodiment, the AMF receives the AAA-S Authorized UE-Slice-MBR from the NSSAAF after a successful NSSAA procedure.

According to an embodiment of the present disclosure, the AMF subscribes the notifications of the updates of the AAA-S Authorized UE-Slice-MBR from the NSSAAF after the reception of the AAA-S Authorized UE-Slice-MBR from the NSSAAF.

According to an embodiment of the present disclosure, the AMF sends the AAA-S Authorized UE-Slice-MBR to the PCF.

According to an embodiment of the present disclosure, the AMF receives the Authorized UE-Slice-MBR from the PCF.

According to an embodiment of the present disclosure, the AMF sends the Authorized UE-Slice-MBR to the RAN.

According to an embodiment of the present disclosure, the NSSAAF receives the AAA-S Authorized UE-Slice-MBR from the AAA-P or the AAA-S. In an embodiment, the NSSAAF receives the AAA-S Authorized UE-Slice-MBR from the AAA-P or the AAA-S during the NSSAA procedure. In another embodiment, the NSSAAF receives the AAA-S Authorized UE-Slice-MBR from the AAA-P or the AAA-S after a successful NSSAA procedure.

According to an embodiment of the present disclosure, the NSSAAF subscribes the notifications of the updates of the AAA-S Authorized UE-Slice-MBR from the AAA-P or the AAA-S after the reception of the AAA-S Authorized UE-Slice-MBR from the AAA-P or the AAA-S.

According to an embodiment of the present disclosure, the NSSAAF sends the AAA-S Authorized UE-Slice-MBR to the AMF.

According to an embodiment of the present disclosure, the PCF receives the AAA-S Authorized UE-Slice-MBR from the AMF.

According to an embodiment of the present disclosure, the PCF sends the Authorized UE-Slice-MBR to the AMF.

According to an embodiment of the present disclosure, the AAA-P receives the AAA-S Authorized UE-Slice-MBR from the AAA-S. In an embodiment, the AAA-P receives the AAA-S Authorized UE-Slice-MBR from the AAA-S during the NSSAA procedure. In another embodiment, the AAA-P receives the AAA-S Authorized UE-Slice-MBR from the AAA-S after a successful NSSAA procedure.

According to an embodiment of the present disclosure, the AAA-P subscribes the notifications of the updates of the AAA-S Authorized UE-Slice-MBR from the AAA-S after the reception of the AAA-S Authorized UE-Slice-MBR from the AAA-S.

According to an embodiment of the present disclosure, the AAA-P sends the AAA-S Authorized UE-Slice-MBR to the NSSAAF.

According to an embodiment of the present disclosure, the AAA-S sends the AAA-S Authorized UE-Slice-MBR to the AAA-P or the NSSAAF. In an embodiment, the AAA-S sends the AAA-S Authorized UE-Slice-MBR to the AAA-P or the NSSAAF during the NSSAA procedure. In another embodiment, the AAA-S sends the AAA-S Authorized UE-Slice-MBR to the AAA-P or the NSSAAF after a successful NSSAA procedure.

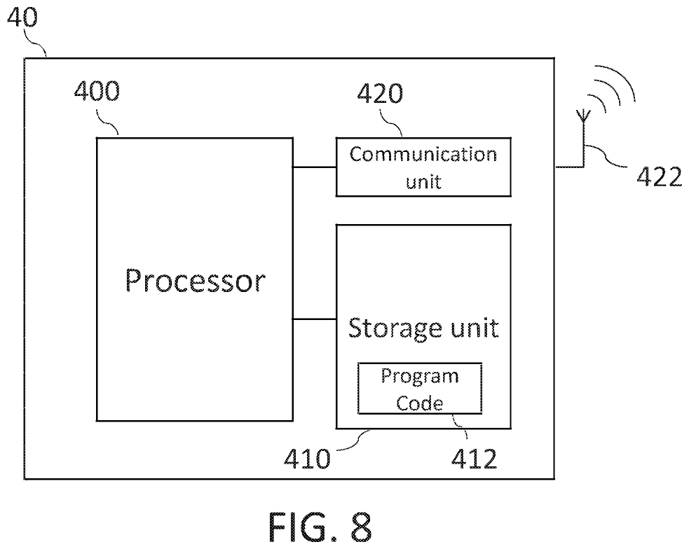

FIG. 8 relates to a schematic diagram of a wireless communication node 40 (e.g., a network device) according to an embodiment of the present disclosure. The wireless communication node 40 may be a satellite, a base station (BS) (e.g., a gNB or a gNB-CU-CP), an Authentication, Authorization, and Accounting-Server (AAA-S), an Authentication, Authorization, and Accounting-Proxy (AAA-P), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), a Unified Data Management (UDM), a network slice Selection Function (NSSF), a network slice specific authentication and authorization function (NSSAAF), a network exposure function (NEF) etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from another wireless communication node and/or a wireless communication terminal.

In some embodiments, the wireless communication node 40 may be used to perform the operations of the AMF, the NSSAAF, the PCF, the AAA-S, the AAA-P, the NEF, the AF, and the UDM described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication node (e.g., an AMF). In an embodiment, the wireless communication node may be implemented by using the wireless communication node 40 described above, but is not limited thereto.

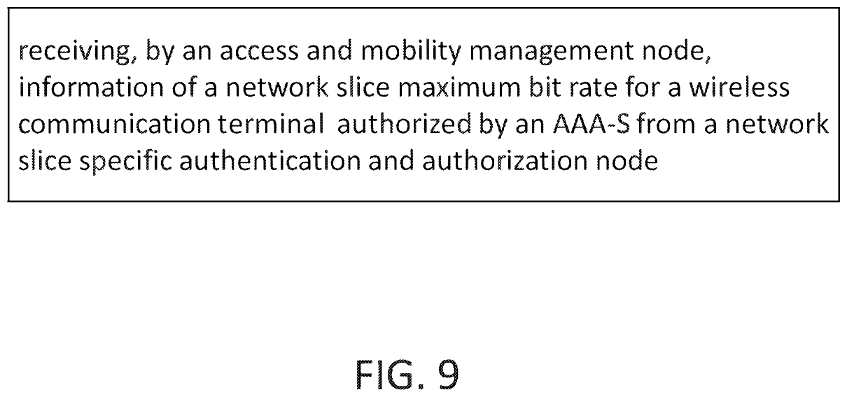

Referring to FIG. 9, in an embodiment, the wireless communication method includes: receiving, by an access and mobility management node, information of a network slice maximum bit rate for a wireless communication terminal authorized by an Authentication, Authorization, and Accounting-Server, AAA-S, from a network slice specific authentication and authorization node.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an NSSAAF). In an embodiment, the wireless communication node may be implemented by using the wireless communication node 40 described above, but is not limited thereto.

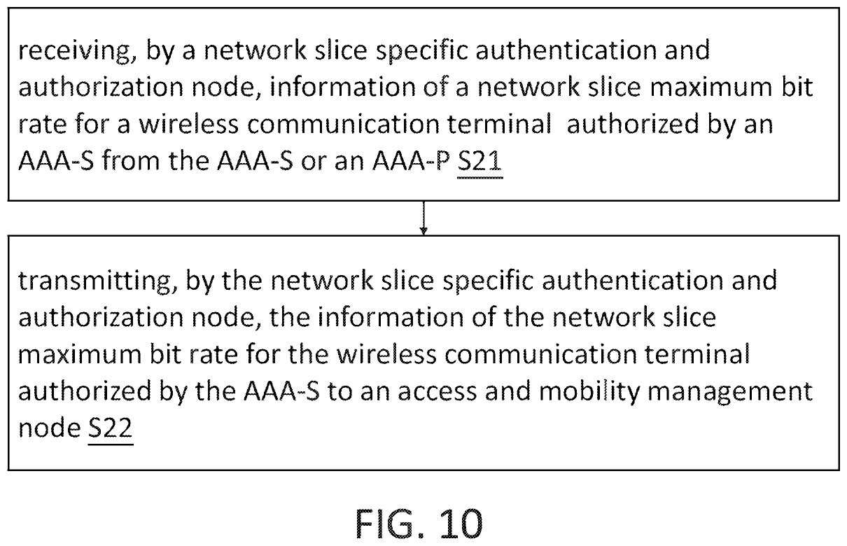

Referring to FIG. 10, in an embodiment, the wireless communication method includes: receiving, by a network slice specific authentication and authorization node, information of a network slice maximum bit rate for a wireless communication terminal authorized by an Authentication, Authorization, and Accounting-Server, AAA-S, from the AAA-S or an Authentication, Authorization, and Accounting-Proxy, AAA-P (S21); and transmitting, by the network slice specific authentication and authorization node, the information of the network slice maximum bit rate for the wireless communication terminal authorized by the AAA-S to an access and mobility management node (S22).

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., a PCF). In an embodiment, the wireless communication node may be implemented by using the wireless communication node 40 described above, but is not limited thereto.

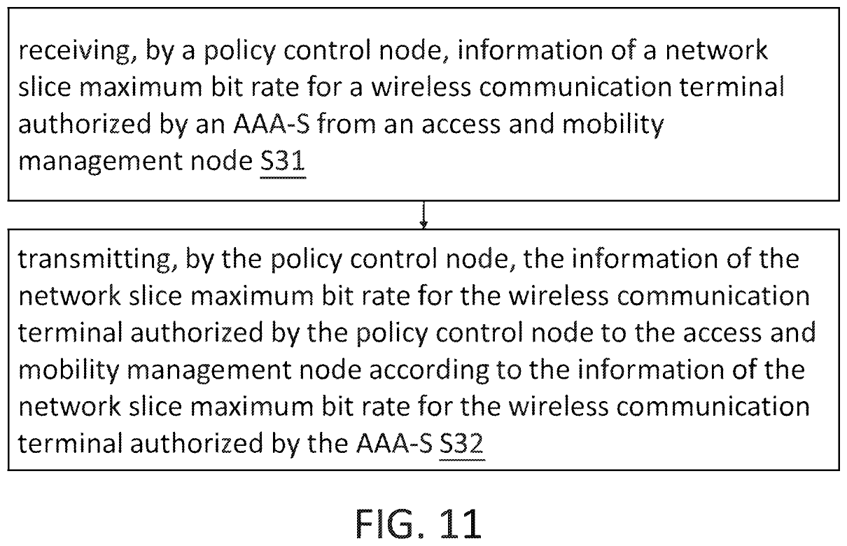

Referring to FIG. 11, in an embodiment, the wireless communication method includes: receiving, by a policy control node, information of a network slice maximum bit rate for a wireless communication terminal authorized by an Authentication, Authorization, and Accounting-Server, AAA-S, from an access and mobility management node (S31); and transmitting, by the policy control node, the information of the network slice maximum bit rate for the wireless communication terminal authorized by the policy control node to the access and mobility management node according to the information of the network slice maximum bit rate for the wireless communication terminal authorized by the AAA-S(S32).

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an AAA-P). In an embodiment, the wireless communication node may be implemented by using the wireless communication node 40 described above, but is not limited thereto.

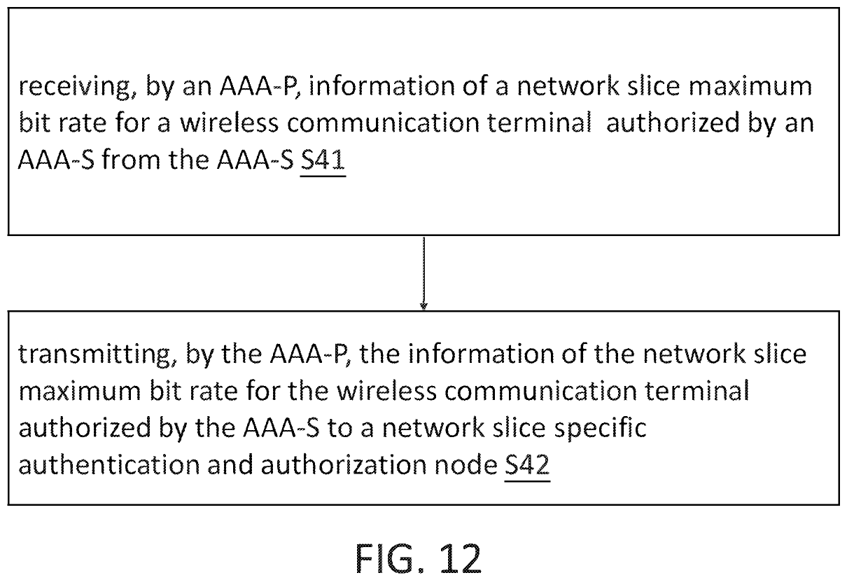

Referring to FIG. 12, in an embodiment, the wireless communication method includes: receiving, by an Authentication, Authorization, and Accounting-Proxy, AAA-P, information of a network slice maximum bit rate for a wireless communication terminal authorized by an Authentication, Authorization, and Accounting-Server, AAA-S, from the AAA-S(S41); and transmitting, by the AAA-P, the information of the network slice maximum bit rate for the wireless communication terminal authorized by the AAA-S to a network slice specific authentication and authorization node (S42).

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., an AAA-S). In an embodiment, the wireless communication node may be implemented by using the wireless communication node 40 described above, but is not limited thereto.

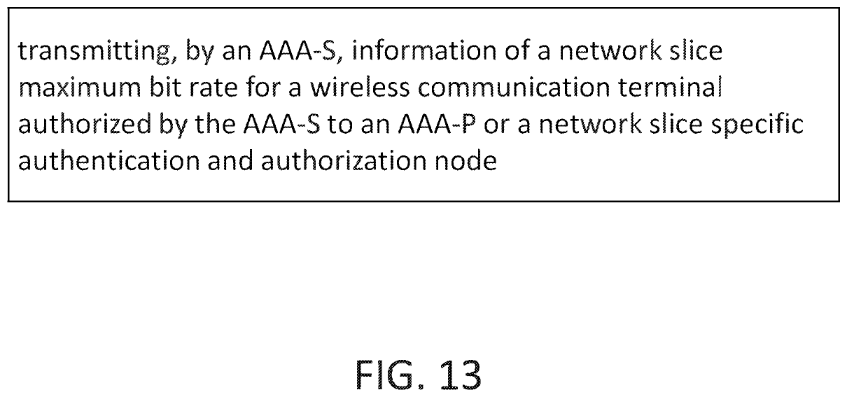

Referring to FIG. 13, in an embodiment, the wireless communication method includes: transmitting, by an Authentication, Authorization, and Accounting-Server, AAA-S, information of a network slice maximum bit rate for a wireless communication terminal authorized by the AAA-S to an Authentication, Authorization, and Accounting-Proxy, AAA-P, or a network slice specific authentication and authorization node.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits, and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components, and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by an access and mobility management node, information of a network slice maximum bit rate for a wireless communication terminal authorized by an Authentication, Authorization, and Accounting-Server (AAA-S) from a network slice specific authentication and authorization node.

2. The wireless communication method of claim 1, wherein the access and mobility management node is configured to transmit the information of the network slice maximum bit rate for the wireless communication terminal authorized by the AAA-S to a policy control node to acquire the information of the network slice maximum bit rate for the wireless communication terminal authorized by the policy control node.

3. The wireless communication method of claim 1, wherein the access and mobility management node is configured to transmit the information of the network slice maximum bit rate for the wireless communication terminal authorized by the AAA-S or the information of the network slice maximum bit rate for the wireless communication terminal authorized by a policy control node to the radio access network, and wherein the information of the network slice maximum bit rate for the wireless communication terminal authorized by the policy control node is acquired by transmitting the information of the network slice maximum bit rate for the wireless communication terminal authorized by the AAA-S to the policy control node.

4. The wireless communication method of claim 1, wherein the access and mobility management node is configured to receive the information of the network slice maximum bit rate for the wireless communication terminal authorized by the AAA-S during a network slice specific authentication and authorization (NSSAA) procedure for a piece of Single-Network Slice Selection Assistant Information (S-NSSAI) for the network slice.

5. The wireless communication method of claim 1, wherein the access and mobility management node is configured to subscribe updates of the information of the network slice maximum bit rate for the wireless communication terminal authorized by the AAA-S from the network slice specific authentication and authorization node.

6. The wireless communication method of claim 1, wherein the access and mobility management node is configured to receive the information of the network slice maximum bit rate for the wireless communication terminal authorized by the AAA-S after a successful NSSAA procedure for a piece of S-NSSAI for the network slice.

7. A wireless communication method comprising:
receiving, by a network slice specific authentication and authorization node, information of a network slice maximum bit rate for a wireless communication terminal authorized by an Authentication, Authorization, and Accounting-Server (AAA-S) from the AAA-S or an Authentication, Authorization, and Accounting-Proxy (AAA-P); and
transmitting, by the network slice specific authentication and authorization node, the information of the network slice maximum bit rate for the wireless communication terminal authorized by the AAA-S to an access and mobility management node.

8. The wireless communication method of claim 7, wherein the network slice specific authentication and authorization node is configured to receive the information of the network slice maximum bit rate for the wireless communication terminal authorized by the AAA-S during a network slice specific authentication and authorization (NSSAA) procedure for a piece of Single-Network Slice Selection Assistant Information (S-NSSAI) for a network slice.

9. The wireless communication method of claim 7, wherein the network slice specific authentication and authorization node is configured to subscribe updates of the information of the network slice maximum bit rate for the wireless communication terminal authorized by the AAA-S from the AAA-S or the AAA-P.

10. The wireless communication method of claim 7, wherein the network slice specific authentication and authorization node is configured to receive the information of the network slice maximum bit rate for the wireless communication terminal authorized by the AAA-S after a successful NSSAA procedure for a piece of S-NSSAI for a network slice.

11. A wireless communication method comprising:
transmitting, by an Authentication, Authorization, and Accounting-Server (AAA-S) information of a network slice maximum bit rate for a wireless communication terminal authorized by the AAA-S to an Authentication, Authorization, and Accounting-Proxy (AAA-P) or a network slice specific authentication and authorization node.

12. The wireless communication method of claim 11, wherein the AAA-S is configured to transmit the information of the network slice maximum bit rate for the wireless communication terminal authorized by the AAA-S during a network slice specific authentication and authorization (NSSAA) procedure for a piece of Single-Network Slice Selection Assistant Information (S-NSSAI) for a network slice.

13. The wireless communication method of claim 11, wherein the AAA-S is configured to receive a subscription for updates of the information of the network slice maximum bit rate for the wireless communication terminal authorized by the AAA-S from the AAA-P or the network slice specific authentication and authorization node.

14. The wireless communication method of claim 11, wherein the AAA-S is configured to transmit the information of the network slice maximum bit rate for the wireless communication terminal authorized by the AAA-S after a successful NSSAA procedure for a piece of S-NSSAI for a network slice.
